(19) United States
(12) Patent Application Publication
(10) Pub. No.: US 2026/0181217 A1
(43) Pub. Date: Jun. 25, 2026

(54) INFORMATION DISPLAY METHOD, COMPUTER DEVICE AND STORAGE MEDIUM

(71) Applicant: Beijing Zitiao Network Technology Co., Ltd., Beijing (CN)

(72) Inventors: Chuanqi JING, Beijing (CN); Peiyu ZHONG, Beijing (CN); Liangjie XIE, Beijing (CN)

(21) Appl. No.: 18/835,015

(22) PCT Filed: Mar. 8, 2024
(86) PCT No.: PCT/CN2024/080734

§ 371 Date: Jul. 31, 2024

(30) Foreign Application Priority Data
Mar. 10, 2023 (CN) 202310251593.8

(51) Int. Cl. H04N 21/466; G06F 3/0482; G06F 3/0483; H04N 21/4788

(52) U.S. Cl. CPC H04N 21/4668; G06F 3/0482; G06F 3/0483; H04N 21/4788

(57) ABSTRACT

An information display method, a computer device and a storage medium are provided. The method includes: displaying a recommendation video corresponding to a target book list, in which the recommendation video is used for recommending books to be recommended that are associated with the target book list, and the recommendation video is generated based on book information corresponding to the books to be recommended; and displaying, in response to a triggering operation on a target book to be recommended in the recommendation video, a reading page corresponding to the target book to be recommended.

The present application claims priority of the Chinese Patent Application No. 202310251593.8, filed on Mar. 10, 2023, the disclosure of which is incorporated herein by reference in its entirety as part of the present application.

### TECHNICAL FIELD

The present disclosure relates to an information method and apparatus, a computer device and a storage medium.

### BACKGROUND

In a reading platform, in order to recommend more books to a user, the introduction information of a plurality of books may be displayed in a form of a list, for example, displaying the covers, names, etc. of books one by one. In this way, the form of displaying information is monotonous and is difficult to attract the user to select a book for reading.

### SUMMARY

Embodiments of the present disclosure provide at least an information method and apparatus, a computer device and a storage medium.

In the first aspect, the embodiments of the present disclosure provide an information method, which includes: displaying a recommendation video corresponding to a target book list, in which the recommendation video is used for recommending books to be recommended that are associated with the target book list, and the recommendation video is generated based on book information corresponding to the books to be recommended; and displaying, in response to a triggering operation on any of the books to be recommended in the recommendation video, a reading page corresponding to the book to be recommended.

In a possible implementation, the recommendation video corresponding to the target book list is determined in the following way: determining video materials for generating the recommendation video based on the book information corresponding to the books to be recommended; and determining a target video type that matches the target book list from a plurality of preset video types, and generating a recommendation video under the target video type for the target book list based on the video materials.

In a possible implementation, the determining video materials for generating the recommendation video based on the book information corresponding to the books to be recommended, includes: acquiring book list information of the target book list, in which the book list information characterizes introduction information of the target book list in a plurality of attribute dimensions; and determining the video materials for generating the recommendation video based on the book information corresponding to the books to be recommended and the book list information.

In a possible implementation, the preset video types include a plurality of types selected from a group of an explanatory type, an image set type and a text reading type; and the generating a recommendation video under the target video type for the target book list based on the video materials, includes: integrating the video materials to obtain the recommendation video according to a video material integration mode corresponding to the target video type.

In a possible implementation, video types include the explanatory type, and a video material integration mode corresponding to the explanatory type includes using different video clips to associate with video materials of different books to be recommended; and the integrating the video materials to obtain the recommendation video according to a video material integration mode corresponding to the video types, includes: extracting a book list title and/or a book list introduction from the video materials, and generating a video cover of the recommendation video according to the book list title and/or the book list introduction; and extracting a book identifier and recommendation information of the books to be recommended from the video materials, and generating a plurality of video clips of the recommendation video according to the book identifier and recommendation information of the books to be recommended, in which the different video clips are associated with the different books to be recommended.

In a possible implementation, video types include the image set type, and a video material integration mode corresponding to the image set type includes: using different video image sets to associate with video materials of different books to be recommended, and using different video images in the video image set to associate with video materials of different information types respectively; and the integrating the video materials to obtain the recommendation video according to a video material integration mode corresponding to the video types, includes: extracting video materials of the books to be recommended respectively under the plurality of the information types from the video materials; and generating the video image sets according to the video materials of the books to be recommended, in which each video image set is used to present the video materials of the corresponding book to be recommended under the plurality of the information types.

In a possible implementation, video types include the text reading type, and a video material integration mode corresponding to the text reading type includes: displaying the video materials in a form of a long text, the long text refers to a text that is longer than a length of a screen; and integrating the video materials to obtain the recommendation video according to a video material integration mode corresponding to the video types, includes: extracting a book list title and/or a book list introduction from the video materials, and taking the book list title and/or the book list introduction as a text content at the first screen position of a corresponding video in the long text; and extracting a book identifier and recommendation information of the books to be recommended from the video materials, and sequentially arranging the book identifier and recommendation information of the books to be recommended in other positions of the long text; and setting a reading mode of the long text as a scrolling playback mode to generate a recommendation video having a text content of the long text as a video content.

In a possible implementation, the book information corresponding to the books to be recommended includes introduction information and recommendation information of the books to be recommended; and the method further includes acquiring the recommendation information corresponding to the books to be recommended in a following way: acquiring at least one piece of comment information associated with the books to be recommended; in response to the at least one piece of comment information including the first comment information and books commented by the first comment information only including the books to be recommended, taking the first comment information as the recommendation information; or, in response to the at least one piece of comment information including the second comment information and books commented by the second comment information including the books to be recommended and other books, selecting target comment information from the second comment information based on comment attribute information of the second comment information in a plurality of comment dimensions, and taking a comment text segment associated with the books to be recommended in the target comment information as the recommendation information of the books to be recommended.

In a possible implementation, the displaying a recommendation video corresponding to a target book list, includes: displaying the recommendation video in the first area of a recommendation video page, and displaying a reading list generated based on the books to be recommended in the second area associated with the first area; and the displaying, in response to a triggering operation on any of the books to be recommended in the recommendation video, a reading page corresponding to the book to be recommended, includes: in response to a triggering operation on any of the books to be recommended in the reading list, displaying the reading page corresponding to the book to be recommended.

In a possible implementation, the displaying a reading list generated based on the books to be recommended in a second area, includes: displaying a list identifier corresponding to the reading list in the second area, and displaying the reading list in response to a triggering operation on the list identifier; and/or, determining a book to be recommended that is associated with a current playback position of the recommendation video, and displaying the book to be recommended in the reading list in the second area.

In a possible implementation, the triggering operation includes a preset triggering operation; and the displaying, in response to a triggering operation on any of the books to be recommended in the recommendation video, a reading page corresponding to the book to be recommended, includes: determining a target playback position indicated by the preset triggering operation in the recommendation video, in order to determine a book to be recommended that is associated with the preset triggering operation based on the target playback position, and displaying the reading page corresponding to the book to be recommended.

In a possible implementation, the information display method further includes: displaying a book list display page corresponding to the target book list, in which the book list display page is used for displaying book information corresponding respectively to a plurality of books to be recommended in the target book list.

In a possible implementation, the displaying a book list display page corresponding to the target book list, includes: displaying respectively the book information corresponding to the books to be recommended, in a plurality of the third areas in the book list display page, in which any of the third areas includes the first sub-area for displaying introduction information in the book information of the book to be recommended, and the second sub-area for displaying recommendation information in the book information; and displaying book list information of the target book list in the fourth area of the book list display page, in which a plurality of attribute dimensions in the book list information include at least one of a book list name of the target book list, a book quantity corresponding to the books to be recommended in the target book list, and a comprehensive reading conversion rate corresponding to the books to be recommended.

In the second aspect, the embodiments of the present disclosure provide an information display apparatus, which includes the first displaying module and the second displaying module. The first displaying module is configured to display a recommendation video corresponding to a target book list, in which the recommendation video is used for recommending books to be recommended that are associated with the target book list, and the recommendation video is generated based on book information corresponding to the books to be recommended. The second displaying module is configured to display, in response to a triggering operation on any of the books to be recommended in the recommendation video, a reading page corresponding to the book to be recommended.

In a possible implementation, the apparatus further includes the first processing module, which is configured to determine the recommendation video corresponding to the target book list in the following way: determining video materials for generating the recommendation video based on the book information corresponding to the books to be recommended; and determining a target video type that matches the target book list from a plurality of preset video types, and generating a recommendation video under the target video type for the target book list based on the video materials.

In a possible implementation, when determining video materials for generating the recommendation video based on the book information corresponding to the books to be recommended, the first processing module is configured to: acquire book list information of the target book list, in which the book list information characterizes introduction information of the target book list in a plurality of attribute dimensions; and determine the video materials for generating the recommendation video based on the book information corresponding to the books to be recommended and the book list information.

In a possible implementation, the preset video types include a plurality of types selected from a group of an explanatory type, an image set type and a text reading type. When generating a recommendation video under the target video type for the target book list based on the video materials, the first processing module is configured to integrate the video materials to obtain the recommendation video according to a video material integration mode corresponding to the target video type.

In a possible implementation, video types include the explanatory type, and a video material integration mode corresponding to the explanatory type includes using different video clips to associate with video materials of different books to be recommended. When integrating the video materials to obtain the recommendation video according to a video material integration mode corresponding to the video types, the first processing module is configured to: extract a book list title and/or a book list introduction from the video materials, and generate a video cover of the recommendation video according to the book list title and/or the book list introduction; and extract a book identifier and recommendation information of the books to be recommended from the video materials, and generate a plurality of video clips of the recommendation video according to the book identifier and recommendation information of the books to be recommended, in which the different video clips are associated with the different books to be recommended.

In a possible implementation, video types include the image set type, a video material integration mode corresponding to the image set type includes using different video image sets to associate with video materials of different books to be recommended, and using different video images in the video image sets to associate with video materials of different information types respectively. When integrating the video materials to obtain the recommendation video according to a video material integration mode corresponding to the video types, the first processing module is configured to: extract video materials of the books to be recommended respectively under the plurality of the information types from the video materials; and generate the video image sets according to the video materials of the books to be recommended, in which each video image set is used to present the video materials of the corresponding book to be recommended under the plurality of the information types.

In a possible implementation, video types include the text reading type, a video material integration mode corresponding to the text reading type includes displaying the video materials in a form of a long text, and the long text refers to a text that is longer than a length of a screen. When integrating the video materials to obtain the recommendation video according to a video material integration mode corresponding to the video types, the first processing module is configured to: extract a book list title and/or a book list introduction from the video materials, and take the book list title and/or the book list introduction as a text content at the first screen position of a corresponding video in the long text; and extract a book identifier and recommendation information of the books to be recommended from the video materials, and sequentially arrange the book identifier and recommendation information of the books to be recommended in other positions of the long text; and set a reading mode of the long text as a scrolling playback mode to generate a recommendation video having a text content of the long text as a video content.

In a possible implementation, the book information corresponding to the books to be recommended includes introduction information and recommendation information of the books to be recommended; and the apparatus further includes the second processing module. The second processing module is configured to acquire the recommendation information corresponding to the books to be recommended in the following way: acquiring at least one piece of comment information associated with the books to be recommended; in response to the at least one piece of comment information including the first comment information and books commented by the first comment information only including the books to be recommended, taking the first comment information as the recommendation information; or, in response to the at least one piece of comment information including the second comment information and books commented by the second comment information including the books to be recommended and other books, selecting target comment information from the second comment information based on comment attribute information of the second comment information in a plurality of comment dimensions, and taking a comment text segment associated with the books to be recommended in the target comment information as the recommendation information of the books to be recommended.

In a possible implementation, when displaying a recommendation video corresponding to a target book list, the first displaying module is configured to display the recommendation video in the first area of a recommendation video page, and display a reading list generated based on the books to be recommended in the second area associated with the first area. When displaying, in response to a triggering operation on any of the books to be recommended in the recommendation video, a reading page corresponding to the book to be recommended, the second displaying module is configured to, in response to a triggering operation on any of the books to be recommended in the reading list, display the reading page corresponding to the book to be recommended.

In a possible implementation, when displaying a reading list generated based on the books to be recommended in a second area, the second displaying module is configured to: display a list identifier corresponding to the reading list in the second area, and display the reading list in response to a triggering operation on the list identifier; and/or, determine a book to be recommended that is associated with a current playback position of the recommendation video, and display the book to be recommended in the reading list in the second area.

In a possible implementation, the triggering operation includes a preset triggering operation. When displaying, in response to a triggering operation on any of the books to be recommended in the recommendation video, a reading page corresponding to the book to be recommended, the second displaying module is configured to: determine a target playback position indicated by the preset triggering operation in the recommendation video, in order to determine a book to be recommended that is associated with the preset triggering operation based on the target playback position, and display the reading page corresponding to the book to be recommended.

In a possible implementation, the apparatus further includes the third displaying module, which is configured to display a book list display page corresponding to the target book list, in which the book list display page is used for displaying book information corresponding respectively to a plurality of books to be recommended in the target book list.

In a possible implementation, when displaying a book list display page corresponding to the target book list, the third displaying module is configured to: display respectively the book information corresponding to the books to be recommended, in a plurality of the third areas in the book list display page, in which any of the third areas includes the first sub-area for displaying introduction information in the book information of the book to be recommended, and the second sub-area for displaying recommendation information in the book information; and display book list information of the target book list in the fourth area of the book list display page, in which a plurality of attribute dimensions in the book list information include at least one of a book list name of the target book list, a book quantity corresponding to the books to be recommended in the target book list, and a comprehensive reading conversion rate corresponding to the books to be recommended.

In the third aspect, the embodiments of the present disclosure provide a computer device, which includes a processor and a memory. The memory stores machine-readable instructions executable by the processor, the processor is used for executing the machine-readable instructions stored in the memory, and when the machine-readable instructions are executed by the processor, the processor executes the steps of the first aspect or any of the possible implementations in the first aspect.

In the fourth aspect, the embodiments of the present disclosure provide a computer-readable storage medium. Computer programs are stored on the computer-readable storage medium, and when the computer programs are run on a computer device, the computer device executes the steps of the first aspect or any of the possible implementations in the first aspect.

In order to make the above-mentioned purposes and features of the present disclosure more obvious and understandable, optional embodiments will be described in detail below together with the accompanying drawings.

### BRIEF DESCRIPTION OF DRAWINGS

In order to illustrate the technical solutions of the embodiments of the present disclosure more clearly, the drawings required to be used in the embodiments are briefly introduced below. The drawings are incorporated into the specification and form a part of the specification. The drawings show the embodiments that conform to the present disclosure, and are used together with the specification to illustrate the technical solutions of the present disclosure. It should be understood that the following drawings only show some embodiments of the present disclosure, and therefore should not be regarded as a limitation of the scope. Other related drawings can also be derived from these drawings by those ordinarily skilled in the art without creative efforts.

FIG. 1 is a flowchart of an information display method provided by an embodiment of the present disclosure;

FIG. 2 is a schematic diagram of a video frame image displayed under a recommendation video of an explanatory type provided by an embodiment of the present disclosure;

FIG. 3 is a schematic diagram of a video frame image displayed under an image set type provided by an embodiment of the present disclosure;

FIG. 4 is a schematic diagram of a long text provided by an embodiment of the present disclosure;

FIG. 5 is a schematic diagram when displaying a video frame image provided by an embodiment of the present disclosure;

FIG. 6 is a schematic diagram when displaying a reading list through a list identifier provided by an embodiment of the present disclosure;

FIG. 7 is a schematic diagram of displaying a reading list provided by an embodiment of the present disclosure;

FIG. 8 is a schematic diagram of a book list display page provided by an embodiment of the present disclosure;

FIG. 9 is a schematic diagram of another information display apparatus provided by an embodiment of the present disclosure; and

FIG. 10 is a schematic diagram of a computer device provided by an embodiment of the present disclosure.

### DETAILED DESCRIPTION

In order to make the purposes, technical solutions and advantages of the embodiments of the present disclosure clearer, the technical solutions in the embodiments of the present disclosure will be clearly and completely described below in conjunction with the accompanying drawings in the embodiments of the present disclosure. Obviously, the described embodiments are only part of the embodiments of the present disclosure, but not all of the embodiments. The components of the embodiments of the present disclosure generally described and illustrated herein may be arranged and designed in a variety of different configurations. Therefore, the following detailed description of the embodiments of the present disclosure is not intended to limit the scope of the claimed disclosure, but merely represents the selected embodiments of the present disclosure. Based on the embodiments of the present disclosure, all other embodiments obtained by those skilled in the art without creative effort shall fall within the protection scope of the present disclosure.

It is found that, in a reading platform, in order to recommend more books to a user, the introduction information of a plurality of books may be displayed in a form of a list, for example, displaying the covers, titles, etc. of books one by one. In this way, the form of displaying information is monotonous and is difficult to attract the user to select a book for reading.

Research indicates that reading platforms usually recommend books to users in a form of a list. When displaying, the book information of the books to be recommended is generally selected to be arranged and displayed in the form of the list. This approach only displays information such as static images, text information, etc., and the form of displaying is monotonous, so it is difficult to attract the user to select a book for reading.

Based on the above research, the present disclosure provides an information display method. When recommending the books to be recommended, a recommendation video of a book list corresponding to the books to be recommended is selected to be displayed, so as to dynamically display the book information of the books to be recommended in a video form on the basis of the original display method of using the static text and images. Thus, the display form is more abundant, and is easier to attract users to select any of books to be recommended that are introduced in the displayed recommendation video for reading according to the displayed recommendation video.

The defects in the above solutions are all the results obtained by the inventors after practice and careful research. Therefore, the discovery process of the above problems and the solutions proposed by the present disclosure below for the above problems should be the contributions to the present disclosure made by the inventors during the process of the present disclosure.

It should be noted that similar numerals and letters denote similar items in the following accompany drawings, therefore, once a certain item is defined in an accompany drawing, the item does not require further definition and explanation in subsequent accompany drawings.

In order to facilitate the understanding of the present embodiments, an information display method disclosed by the embodiments of the present disclosure is firstly introduced in detail. The execution subject of the information display method provided by the embodiments of the present disclosure is generally a computer device with a certain computing capability. The computer device includes, for example, a terminal device, a server or other processing device, and the terminal device may be a user equipment (UE), a mobile equipment, a user terminal, a terminal, a cellular phone, a cordless phone, a personal digital assistant (PDA), a handheld device, a computing device, a vehicle-mounted device, a wearable device, etc. In some possible implementations, the information display method may be implemented in a method of a processor invoking computer-readable instructions stored in a memory.

The information display method provided by the embodiments of the present disclosure are explained below. The information display method provided by the embodiments of the present disclosure can be applied to a reading platform. In an existing reading platform, when displaying books to be recommended to recommend books to users for reading, the books to be recommended to recommend are generally arranged and displayed in a form of a list. This static display of text and image information is not very appealing to the users. However, the information display method provided by the embodiments of the present disclosure displays the book information of the books to be recommended in a dynamic video form, and displays more comprehensive information. In addition, when displaying a recommendation video, the user can select and read any of the books to be recommended displayed in the recommendation video, the operation is more convenient and consistent, and the user can read directly without the need to search or look up a book again.

Moreover, the information display method provided by the embodiments of the present disclosure can also be applied to other video-playing platforms, such as a short video platform or a shopping platform. After playing a recommendation video, in response to a triggering operation on any of the books to be recommended in the recommendation video, a reading page corresponding to the book to be recommended can be jumped to, or a reading page that displays the trial reading part including the book to be recommended can be jumped to. The specific can be determined according to the actual situation and will not be elaborated further here.

Referring to FIG. 1, which is a flowchart of an information display method provided by an embodiment of the present disclosure, the method includes steps S101-S102.
S101: displaying a recommendation video corresponding to a target book list, in which the recommendation video is used for recommending books to be recommended that are associated with the target book list, and the recommendation video is generated based on book information corresponding to the books to be recommended.
S102: displaying, in response to a triggering operation on any of the books to be recommended in the recommendation video, a reading page corresponding to the book to be recommended.

The above-mentioned S101-S102 will be illustrated in detail below.

With respective to the S101, the target book list will be illustrated first. In a possible situation, the plurality of the books to be recommended can be determined according to the method used to select books to be recommended in a platform, such as taking newly released books or recently updated ones as the books to be recommended, and a set of these books to be recommended is taken as the target book list. In another possible situation, such as in the above-mentioned book reading platform, which also includes user-created book lists or a plurality of books associated with a book topic, these book lists or sets of the books under the topic can be determined as the target book list according to a specific filtering criterion. For example, in response to the topic popularity of a certain topic exceeding a certain popularity value, the plurality of the books associated with the topic can be taken as the books to be recommended, and the set of the books to be recommended can be taken as the target book list. The specific can be determined according to the actual situation and will not be further elaborated here.

For example, in the situation of determining the target book list based on a book topic, for example, the following rules may be applied. In response to at least 20 books existing under a certain book topic and having been displayed to at least 1000 users, and at least 20% of the users who viewed the book topic having read the books associated with the book topic, then the target book list may be determined by using the books associated with the book topic. In a possible scenario where the quantity of books in the target book list is limited, in response to excessive books that are associated with the book topic, the associated books further need to be filtered. During filtering, the books may be arranged based on their reading conversion rates, books with higher reading conversion rates are selected as the books in the target book list. For example, after ranking the reading conversion rates from highest to lowest, the top 4 books with the highest reading conversion rates are taken as the books to be recommended in the target book list. Here, the specific details regarding the reading conversion rates are provided below, the quantity of the books to be recommended in the target book list may range from 4 to 20, which can be determined specifically according to the actual situation and will not be further elaborated here.

The recommendation video corresponding to the target book list is specifically a video displayed to a user, and the purpose of displaying is to prompt the user to read the interesting books involved in the recommendation video. Therefore, when generating the recommendation video of the target book list, the recommendation video may be generated according to the book information corresponding to the books to be recommended in the target book list.

In the specific implementation, the recommendation video corresponding to the target book list is determined by the following steps: determining video materials for generating the recommendation video based on the book information corresponding to the books to be recommended; and determining a target video type that matches the target book list from a plurality of preset video types, and generating a recommendation video under the target video type for the target book list based on the video materials.

The book information corresponding to the book to be recommended may specifically include the name, author, brief instruction, trial reading selection, and recommendation information of the book to be recommended. Here, the other information except for the recommendation information, can specifically introduce the books to be recommended, thus can be taken as the introduction information in the book information. The recommendation information mainly includes the comment information on the books to be recommended, which are used to recommend the books to be recommended. Therefore, the book information can be taken as the video materials to generate the recommendation video.

When acquiring the book information, firstly, the introduction information may be directly acquired, because the information of the book to be recommended, such as the title, etc., are already determined. When acquiring the recommendation information corresponding to the books to be recommended, as mentioned above, the recommendation information may be determined according to at least one piece of comment information associated with the books to be recommended, the at least one piece of comment information associated with the books to be recommended is acquired first. After determining the comment information associated with the books to be recommended, the recommendation information may be determined in two different ways: a or b.

In the a, in response to the at least one piece of comment information including the first comment information and books commented in the first comment information only including the books to be recommended, taking the first comment information as the recommendation information.

In the situation, for example, in the replies related to the book to be recommended under a book topic, comment information is only around the book to be recommended, then the at least one piece of comment information acquired is only related to the book to be recommended. In the embodiment of the present disclosure, the comment information that only comments on a single book to be recommended, is termed as the first comment information. The first comment information may be directly taken as the recommendation information. In a possible scenario, in response to only one piece of the first comment information, the first comment can be directly taken as the recommendation information.

In another possible scenario, when there are pieces of the first comment information, the pieces of the first comment information are integrated, such as retaining the comment keywords about the books to be recommended from the pieces of the first comment information and organizing the comment keywords into readable sentences. For example, the pieces of the first comment information include “This book has a fluent logic and tells a compelling story” and “This book is recommended because of the vivid portrayal of the main character”, then “fluent logic”, “compelling story” and “vivid portrayal” may be extracted as the comment keywords, and further organized into a coherent sentence, such as “This book features a fluent logic, a compelling story, and vivid portrayal” as the recommendation information.

In the b, in response to the at least one piece of comment information including the second comment information and books commented in the second comment information including the books to be recommended and other books, selecting target comment information from the second comment information based on comment attribute information of the second comment information in a plurality of comment dimensions, and taking a comment text segment associated with the books to be recommended in the target comment information as the recommendation information of the books to be recommended.

In the situation, for example, in a reply under a book topic, a user offers recommendations and comparisons for a plurality of books in similar types, then the recommendation information associated with a certain book to be recommended not only involves the book to be recommended, but also includes other books. In the embodiments of the present disclosure, the acquired comment information is termed as the second comment information.

In a possible scenario, the quantity of pieces of the second comment information may be very large, in response to using a method similar to the a above, the amount of the data processed for integration may be large, and not all the pieces of the second comment information may offer a valid evaluation of the book to be recommended. For example, the second comment information includes “Book B has a fluent logic and tells a compelling story, better than Book A”, then when the Book A is taken as the book to be recommended, no valid evaluation can be directly acquired from such the second comment information.

Therefore, in the embodiments of the present disclosure, the second comment information is filtered according to the comment attribute information of each piece of the second comment in the plurality of the evaluation dimensions, and the recommendation information of the book to be recommended is determined according to the target comment information obtained from filtration. Specifically, the plurality of evaluation dimensions selected may include an evaluation dimension of whether the second comment information has a five-star praise, a public visibility dimension of whether the comment information is visible, a word count dimension of whether the quantity of words is within the range of 15 to 200, an interaction dimension of whether there is a high quantity of likes, and an objectivity dimension of whether the comment information is originally from the author. Through the above plurality of comment dimensions and filtration based on the objectivity dimension dimensions, the target comment information obtained may be considered as a high-quality comment. By using the target comment information, the comment text segment associated with the books to be recommended may be acquired from the target comment information and be taken as the recommendation information.

Here, the quantity of pieces of the target comment information filtered may be one or more than one. In a possible scenario, when determining the target comment information, after ranking the at least one piece of the second comment information based on the above-mentioned plurality of evaluation dimensions, the top-ranked second comment information can be taken as the target comment information to determine the recommendation information of the books to be recommended. When the determined second comment information still cannot provide a valid comment information on the books to be recommended, other pieces of the second comment may also be selected in order of ranking to determine the recommendation information of the books to be recommended. The specific can be determined according to the actual situation and will not be further elaborated here

Thus, the corresponding recommendation information can be determined for the book to be recommended, which may be combined with the introduction information of the book to be recommended to form the book information of the book to be recommended.

In a possible scenario, besides using the book information of the books to be recommended to generate the recommendation video, because all of the books to be recommended are the books from the target book list, the related information of the target book list can also be taken as video materials for generating the recommendation video when determining the recommendation video of the target book list. Therefore, when determining video materials for generating the recommendation video based on the book information corresponding to the books to be recommended may, it may use the following way: acquiring book list information of the target book list, in which the book list information characterizes the introduction information of the target book list in a plurality of attribute dimensions; and determining the video materials for generating the recommendation video based on the book information corresponding to the books to be recommended and the book list information.

Here, the book list information of the target book list may specifically include the introduction information in the plurality of the attribute dimensions. The plurality of the attribute dimensions may specifically include a book list title of the target book list, a book quantity corresponding to the books to be recommended in the target book list, and a comprehensive reading conversion rate corresponding to the books to be recommended.

For example, the book list title may be determined based on the source of the target book list. For example, when the target book list is sourced from a book topic, the book list title may be determined based on a title of the relevant book topic, or alternatively, the book list title may also be matched as “bestsellers book list”, “updating book list”, etc. Additionally, when the target book list is sourced from a book topic, the attribute dimensions of the book list information may also include a book list introduction, and the introduction information given below the book list introduction may be a topic introduction of the relevant book topic.

The book quantity and the comprehensive reading conversion rate will be explained below. For example, a specific target book list “Book List A” includes 4 books to be recommended, then the book quantity is 4. When determining the comprehensive reading conversion rate corresponding to the books to be recommended, the sum of the reading conversion rates corresponding to each book to be recommended can be taken as the comprehensive reading conversion rate. The reading conversion rate specifically indicates the quantity of users who read the books to be recommended after displaying the books to be recommended to the users. For example, for the first book “Book A” in “Book List A”, the quantity of users who read the books to be recommended is 5 after recommending and displaying to the users, the corresponding reading conversion rate is 5.

Thus, by using the acquired book list information of the target book list and the book information corresponding to the books to be recommended under the target book list, the video materials for generating the recommendation video may be determined.

When generating the recommendation video by using the video materials, because the recommendation video may have different kinds of video types, the corresponding recommendation video can be generated by using the video materials according to the selected target video type of the recommendation video.

For example, preset video types that may be selected as the target video type, may include an explanatory type, an image set type or a text reading type specifically. The three different preset video types will be described in detail below, and will not be further elaborated here. Under different video types, a corresponding video material integration mode may be adopted to integrate the video materials to obtain the recommendation video.

The three preset video types mentioned above will be described below.

### (1) Explanatory Type

Under this type, the style of the recommendation video is instructional by introducing each book to be recommended in the target book list individually and highlighting the key content of the books to be recommended.

Specifically, a video material integration mode of the specific video type includes using different video clips to associate with video materials of different books to be recommended. For example, the above-mentioned target book list “Book List A” includes 4 books to be recommended, then the recommendation video generated correspondingly includes 4 video clips that corresponds to the 4 books to be recommended one by one, and each video clip is associated with a book to be recommended.

In the specific implementation, the video materials may be integrated by this video material integration mode to obtain the recommendation video in the following ways: extracting a book list title and/or a book list introduction from the video materials, and generating a video cover of the recommendation video according to the book list title and/or the book list introduction; and extracting a book identifier and recommendation information of the books to be recommended from the video materials, and generating a plurality of video clips of the recommendation video according to the book identifier and recommendation information of the books to be recommended, in which different video clips are associated with different books to be recommended.

The determining a recommendation video for “Book List A” described above is still taken as an example. Firstly, the recommendation video includes video clips associated with the 4 books to be recommended, however, before displaying the 4 video clips, the book list information corresponding to the target book list may also be displayed. Therefore, a video cover for the recommendation video may be generated by extracting the book list title and/or book list introduction corresponding to the target book list from the video materials acquired.

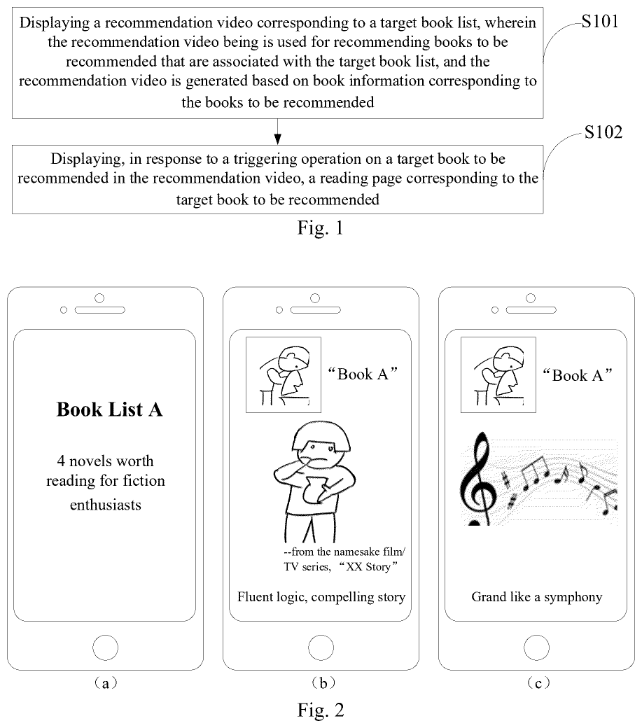

For example, referring to FIG. 2, which is a schematic diagram of a video frame image displayed under a recommendation video of an explanatory type provided by an embodiment of the present disclosure, the video cover of the recommendation video is displayed in FIG. 2(a). Specifically, the video cover displays the book list title “Book List A” and the book list introduction: “4 novels worth reading for fiction enthusiasts”. Here, in a possible scenario, in response to the display time of the video cover being short, then the information displayed on the video cover may be minimal or more concise, serving the purpose of a brief introduction. In another possible scenario, in response to the display time of the video cover being relatively long, then the video cover may accommodate more information, and the information may be further selected to be displayed sequentially on the video cover.

The video clips corresponding to the books to be recommended may specifically display the book identifiers and recommendation information of the corresponding books to be recommended. The book identifier here may be the title or book cover of the book to be recommended. In a possible scenario, the book identifier and recommendation information of the book to be recommended may be displayed frame by frame, or the book identifier may be taken as the title of each video frame, followed by updating and displaying the recommendation information frame by frame. To enrich the visual content of the recommendation video, the images or video clips related to the book to be recommended or recommendation information may be displayed when generating the recommendation video, for example, displaying illustrations of the book to be recommended or video clips of the relevant movies or TV shows. Additionally, the audio for the text may also be played in the background through narration, which may be determined according to the actual situation specifically.

For example, referring to FIG. 2(b) and FIG. 2(c), two video frames from the video clips in the recommendation video corresponding to the book to be recommended “XX Story” are shown. In both frames, the title and book cover of “XX Story” are displayed at the top portion. In the middle position, FIG. 2(b) displays a video clip from a film/TV series associated with the book to be recommended, so the source information is displayed “-- from the namesake film/TV series, ‘XX Story’”. FIG. 2(c) displays the images related to the recommendation information below “Grand like a symphony”, such as the images of musical notes associated with “symphony” in FIG. 2(c). The bottoms of the two images respectively display recommendation information that has different texts, including “Fluent logic, compelling story” displayed in FIG. 2(b) and “Grand like a symphony” displayed in FIG. 2(c).

Thus, a recommendation video under the explanatory type can be obtained.

### (2) Image Set Type

Under this type, the style of the recommendation video is similar to a slide deck, and a page that is similar to flipping the page to display the plurality of images can be provided, which aims to provide clear and concise information when playing the recommendation video.

Specifically, a video material integration mode determined under the mage set type includes using different video image sets to associate with video materials of different books to be recommended, and using different video images in the video image set to associate with video materials of different information types.

Similar to the recommendation video of the above-mentioned explanatory type, for the recommendation video under the image set type, different books to be recommended may be introduced and recommended by correspondingly using different video clips, or the video materials of the books to be recommended under different information types may be selected to be displayed in a centralized manner. The specific can be determined according to the actual situation. The information types illustrated here may include the book introduction and the comment information as mentioned above, and may further include book contents, scores, and the quantity of readers, etc.

In the specific implementation, video materials of the books to be recommended under the plurality of the information types may be extracted from the video materials; and according to the video materials of the books to be recommended, the video image sets are generated. Here, each video image set is used to present the video materials of the corresponding book to be recommended under the plurality of the information types.

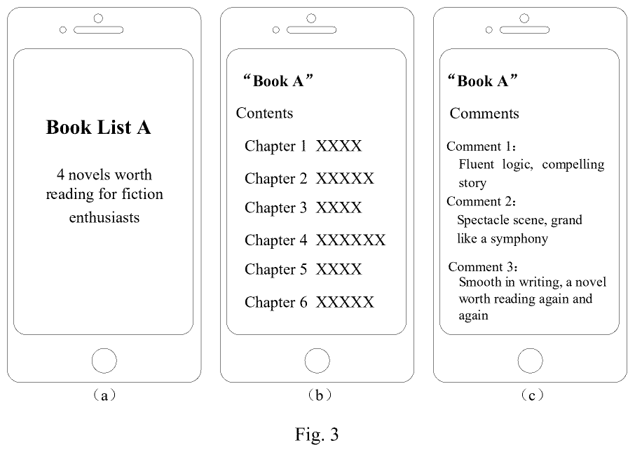

For example, the determining corresponding video clips for each book to be recommended in the recommendation video is still taken as an example for illustration. First, the cover of the recommendation video may be taken as an image in the video image set and may be displayed for 1-2 seconds. The book list title and introduction may be used to create when determining the cover of the recommendation video. For example, FIG. 3 is a schematic diagram of a video frame image displayed under an image set type provided by an embodiment of the present disclosure. FIG. 3(a) shows the video cover of the recommendation video, and the book list title “Book List A” and the book list introduction are displayed in the video cover. Unlike FIG. 2 mentioned above, all video frames in FIG. 3 are displayed using images, so as to obtain the recommendation video. For example, an image is generated according to the book list title and book list introduction, and then the image is displayed for a plurality of seconds to be taken as the initial video frames in the recommendation video.

With respective to “Book A”, for example, different images may also be produced according to the corresponding video materials such contents, pieces of comment information, etc., and these images are taken as the video image set of “Book A”. For example, FIG. 3(b) demonstrates a video frame image when playing the images generated from the contents of “Book A”, and FIG. 3(c) demonstrates a video frame image when playing the images generated from the pieces of comment information.

Thus, a recommendation video under the image set type can be obtained.

### (3) Text Reading Type

Under this type, the style of the recommendation video is experiential reading, i.e., using videos to simulate the user's behaviors during actual reading.

Specifically, the video material integration mode corresponding to this video type includes displaying the video materials in a form of long text. Here, the long text refers to the text that is longer than the length of a screen. When a user reads a book on a reading platform, longer text information cannot be displayed on a single screen because of screen size limitations, so the information is displayed in the form of a long text. To replicate the authentic reading behavior, the video materials acquired may be transformed into a long text, and the long text scrolled for playback to generate the recommendation video.

The long text may be generated in the following ways: extracting a book list title and/or a book list introduction from the video materials, and taking the book list title and/or the book list introduction as a text content at the first screen position of a corresponding video in the long text; and extracting a book identifier and recommendation information of the books to be recommended from the video materials, and sequentially arranging the book identifier and recommendation information of the books to be recommended in other positions of the long text.

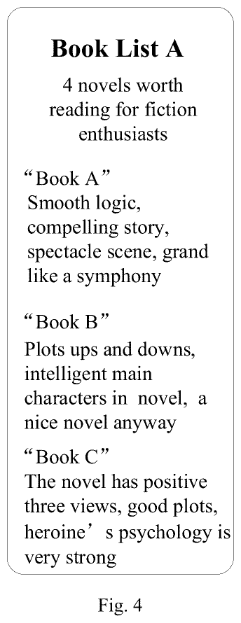

For example, referring to FIG. 4, FIG. 4 is a schematic diagram of a long text provided by an embodiment of the present disclosure. The top portion of the long text displays the book list title and book list introduction, the part of the information corresponds to the first screen position for playing the recommendation video and is displayed first. In addition, the length of the part of the information may be correspond to the screen length. The part after the top portion may display the book identifiers and recommendation information of the books to be recommended, such as the book titles, recommendation information, etc. Specifically, the information associated with three books to be recommended is listed in FIG. 4.

When displaying the long text in FIG. 4, a reading mode of the long text may be set as a scrolling playback mode to generate a recommendation video having a text content of the long text as a video content. For example, referring to FIG. 5, which is a schematic diagram when displaying a video frame image provided by an embodiment of the present disclosure, a principle diagram when displaying a long text is shown in FIG. 5(a), and because the text length exceeds the screen length, only part of the long text can be displayed during displaying. The first video frame image displayed when displaying the long text is shown in FIG. 5(b). FIG. 5(c) shows another video frame image that can be displayed when setting the scrolling playback mode as the reading mode of the long text.

Thus, a recommendation video under the text reading type can be obtained.

After acquiring a recommendation video corresponding to the target book list according to the above method, the recommendation video can be displayed. In a possible scenario, to enable a user to read the books to be recommended involved in the recommendation video, when displaying the recommendation video, the recommendation video may be displayed in the first area of a recommendation video page, and a reading list generated based on each book to be recommended may be displayed in the second area associated with the first area.

The reading list generated based on the books to be recommended may be displayed in the second area in the two following ways.

The first way is to display a list identifier corresponding to the reading list in the second area.

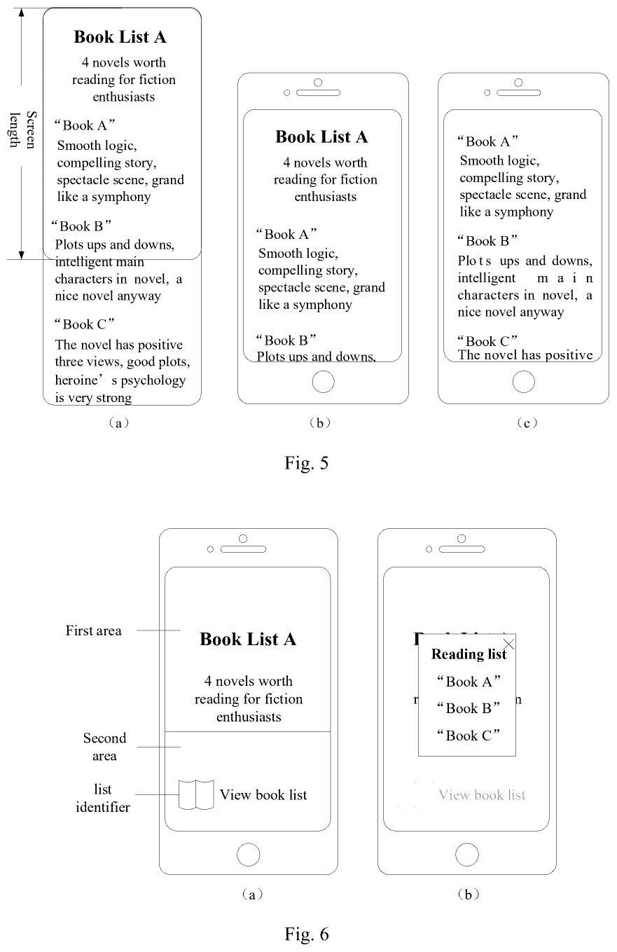

For example, referring to FIG. 6, FIG. 6 is a schematic diagram when displaying a reading list through a list identifier provided by an embodiment of the present disclosure. In FIG. 6(a), the recommendation video is displayed in the first area, and the list identifier is displayed in the second area. In response to a triggering operation on the list identifier, the reading list shown in FIG. 6(b) may be displayed. In the example, the reading list is displayed in a floating window form. In other possible implementations, a bottom pop-up or opening a new page may also be selected for display.

The second way is to determine a book to be recommended that is associated with a current playback position of the recommendation video, and display the book to be recommended in the reading list in the second area.

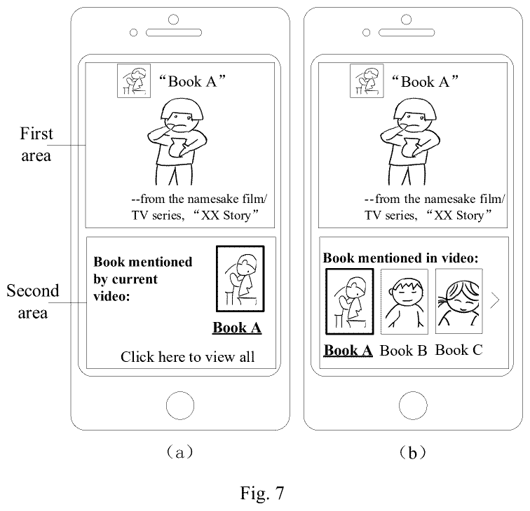

In a possible scenario, the book to be recommended associated with the current playback position may be displayed in the second area, i.e., only one book to be recommended is displayed in the second area. For example, referring to FIG. 7, FIG. 7 is a schematic diagram when displaying a reading list provided by an embodiment of the present disclosure. FIG. 7(a) displays only one book to be recommended that is associated with the current playback position. While the video is playing, the associated book to be recommended will also change, so the book to be recommended displayed in the second area will keep changing along with the video playback. In addition, a control for viewing all books to be recommended is also provided for users to view.

In another possible scenario, all the books to be recommended in the reading list may also be displayed, and referring to FIG. 7(b), the reading list is displayed in the second area. In a possible scenario, in response to playing the recommendation video in full screen, then the first area corresponds to the full screen area, and the second area may be a part of the first area, such as overlaying the reading list in a floating window form above the first area for display. Because of space constraints, when there are many books to be recommended that are displayed in the second area, only part of the books to be recommended may be displayed, and a control for displaying or browsing other books to be recommended is provided. Moreover, the book to be recommended associated with the current playback position may be highlighted for display. Similarly, while the video is playing, the associated book to be recommended will also change, so the highlighted book to be recommended in the second area will also change.

Thus, the display for the recommendation video corresponding to the target book list can be finished, and the associated books to be recommended in the recommendation video are displayed through the reading list.

With respective to the above S102, since the purpose of displaying the recommendation video as explained above, is to show users the books to be recommended and to attract the users to read the books to be recommended, after displaying the recommendation video, in response to a triggering operation on any of the books to be recommended in the recommendation video, a reading page corresponding to the book to be recommended may be displayed.

In a possible scenario, when the reading list generated based on the books to be recommended in the recommendation video is displayed together with the recommendation video, then in response to a triggering operation on any of the books to be recommended in the reading list, a reading page corresponding to the book to be recommended is displayed.

For example, for the pages shown in FIGS. 6(b) and 7, a reading list is displayed. In response to the triggering operation of a user on any of the books to be recommended, a reading page corresponding to the book to be recommended may be displayed, so that the user can read through the reading page.

In another possible scenario, the reading list may not be displayed, or the display of the reading list may be hidden. In this scenario, to achieve the same purpose of “one-click jump” to open the reading page, in response to a preset triggering operation on the recommendation video, such as three-finger swipe, screen double-tap, and other specific triggering actions, a target playback position indicated by the preset triggering operation in the recommendation video may be determined, so as to determine a book to be recommended that is associated with the preset triggering operation based on the target playback position, and display the reading page corresponding to the book to be recommended.

For example, according to the above description of the recommendation video, the recommendation video includes the video frames for introducing the target book list and the video frames for introducing the books to be recommended in the target book list, so it can be determined which video frame the preset triggering operation is aimed at. In the specific implementation, based on the target playback position indicated by the preset triggering operation in the recommendation video, the video frames in the target playback position can be determined, so as to determine the book to be recommended that is associated with the video frames.

Here, in a possible scenario, in response to the determined video frames being the video frames for introducing the target book list, a specific book to be recommended can still not be determined. In this scenario, the triggering operation may be considered as an accidental touch behavior of the user, and the playback of the recommendation video will continue without jumping to the reading page of any book to be recommended. In another possible scenario, it is assumed that the preset triggering operation is intended for viewing all the books to be recommended that are associated with the recommendation video, then the reading list of the target book list in FIG. 6 or FIG. 7 may be displayed. In another possible scenario, the reading page corresponding to the first book to be recommended in the target book list may be displayed, and a switch button is provided for switching to the reading pages of other books to be recommended, so as to satisfy the user's reading requirements for each book to be recommended in the target book list.

In another possible scenario, when the determined video frames are the video frames for introducing a specific book to be recommended determined from the target book list, then in response to a preset triggering operation, the reading page corresponding to the book to be recommended may be displayed. This reading page may also specifically display a switch button for switching to the reading pages of other books to be recommended in the target book list, a return button for returning to continue watching the recommendation video, and a setting button for playing the recommendation video in a small window.

In another embodiment of the present disclosure, a corresponding book list display page may also be provided for the above-mentioned target book list. The book list display page may be used for respectively displaying book information corresponding to the plurality of books to be recommended in the target book list. In a possible scenario, a switch button for switching to the book list display page may be displayed when displaying the recommendation video, so as to jump to the book list display page from the page that displays the recommendation video. The book list display page may be a complement to the recommendation video, correspondingly providing information display in a static form, such as texts, images, etc., so as to enable the platform to introduce the books to be recommended in a more comprehensive and diverse display form, as well as allowing users to select books according to their own preferences.

The book list display page corresponding to the target book list may be displayed in the following way: displaying respectively the book information corresponding to the books to be recommended, in a plurality of the third areas in the book list display page, any of the third areas including the first sub-area for displaying the introduction information in the book information of the book to be recommended, and the second sub-area for displaying the recommendation information in the book information; and displaying the book list information of the target book list in the fourth area of the book list display page.

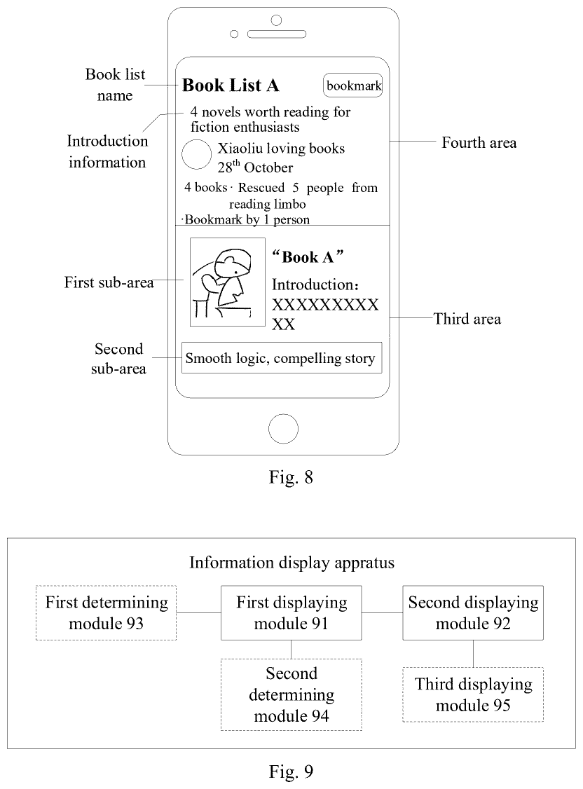

For example, referring to FIG. 8, FIG. 8 is a schematic diagram of a book list display page provided by an embodiment of the present disclosure. Taking the above-mentioned target book list including “Book List A” as an example, first, the book list information of the target book list is displayed in the fourth area. Here, the book list information specifically includes the book list name “Book List A”; the introduction information stating “4 novels worth reading for fiction enthusiasts”; the quantity of books to be recommended 4, specifically denoted as “4 books” on the book list display page; and the comprehensive reading conversion rate of 5 for the books to be recommended, specifically denoted as “Rescued 5 people from reading limbo” on the book list display page. In addition, the quantity of users who have bookmarked the target book list, the generation time of the target book list, the introduction information of the target book list, the information about the creator of the book list may also be displayed, a bookmark button for the target book list is displayed correspondingly.

In the third area, the book information of the books to be recommended is displayed. In the example provided in FIG. 8, only the book information of one book to be recommended in the target book list is displayed because of space constraints. When arranging and displaying the books to be recommended in the third area, the displaying order may be consistent with the order of the books to be recommended in the target book list. As an example, displaying the book information corresponding to “Book A” is illustrated in FIG. 8. The third area corresponding to “Book A” includes the first sub-area for displaying the introduction information of the book to be recommended, and the second sub-area for displaying the recommendation information of the book to be recommended.

The introduction information corresponding to the book to be recommended may include the brief introduction of the book, the author information, the book cover, the book rating, etc. The specific recommendation information may be determined according to the way of determining the recommendation information in the above-mentioned embodiment, and the details are not repeated here.

Thus, the user can quickly acquire relevant information about the books to be recommended through text and image information on the book list display page.

It can be understood by those skilled in the art that in the above-mentioned method according to specific implementations, the order of writing the steps does not necessarily imply a strict execution sequence or impose any limitations on the implementation process. The specific execution sequence of each step should be determined based on its functionality and possible inherent logic.

Based on the same invention concept, the embodiments of the present disclosure further provide an information display apparatus corresponding to the information display method. Because the principle of solving problems by the apparatus in the embodiments of the present disclosure is similar to the above-mentioned information display method in the embodiments of the present disclosure, the implementation of the apparatus can refer to the implementation of the method, which will not be repeated here.

Referring to FIG. 9, which is a schematic diagram of another information display apparatus provided by an embodiment of the present disclosure, the apparatus includes the first displaying module 91 and the second displaying module 92.

The first displaying module 91 is configured to display a recommendation video corresponding to a target book list. The recommendation video is used for recommending books to be recommended that are associated with the target book list, and the recommendation video is generated based on book information corresponding to the books to be recommended.

The second displaying module 92 is configured to display, in response to a triggering operation on any of the books to be recommended in the recommendation video, a reading page corresponding to the book to be recommended.

In a possible implementation, the apparatus further includes the first processing module 93, which is configured to determine the recommendation video corresponding to the target book list in the following way: determining video materials for generating the recommendation video based on the book information corresponding to the books to be recommended; and determining a target video type that matches the target book list from a plurality of preset video types, and generating a recommendation video under the target video type for the target book list based on the video materials.

In a possible implementation, when determining video materials for generating the recommendation video based on the book information corresponding to the books to be recommended, the first processing module 93 is configured to: acquire book list information of the target book list, in which the book list information characterizes introduction information of the target book list in a plurality of attribute dimensions; and determine the video materials for generating the recommendation video based on the book information corresponding to the books to be recommended and the book list information.

In a possible implementation, the preset video types include a plurality of types selected from a group of an explanatory type, an image set type and a text reading type. When generating a recommendation video under the target video type for the target book list based on the video materials, the first processing module 93 is configured to integrate the video materials to obtain the recommendation video according to a video material integration mode corresponding to the target video type.

In a possible implementation, video types include the explanatory type, and a video material integration mode corresponding to the explanatory type includes using different video clips to associate with video materials of different books to be recommended. When integrating the video materials to obtain the recommendation video according to a video material integration mode corresponding to the video types, the first processing module 93 is configured to: extract a book list title and/or a book list introduction from the video materials, and generate a video cover of the recommendation video according to the book list title and/or the book list introduction; and extract a book identifier and recommendation information of the books to be recommended from the video materials, and generate a plurality of video clips of the recommendation video according to the book identifier and recommendation information of the books to be recommended, in which the different video clips are associated with the different books to be recommended.

In a possible implementation, video types include the image set type, a video material integration mode corresponding to the image set type includes using different video image sets to associate with video materials of different books to be recommended, and using different video images in the video image sets to associate with video materials of different information types respectively. When integrating the video materials to obtain the recommendation video according to a video material integration mode corresponding to the video types, the first processing module 93 is configured to: extract video materials of the books to be recommended respectively under the plurality of the information types from the video materials; and generate the video image sets according to the video materials of the books to be recommended, in which each video image set is used to present the video materials of the corresponding book to be recommended under the plurality of the information types.

In a possible implementation, video types include the text reading type, a video material integration mode corresponding to the text reading type includes displaying the video materials in a form of a long text, and the long text refers to a text that is longer than a length of a screen. When integrating the video materials to obtain the recommendation video according to a video material integration mode corresponding to the video types, the first processing module 93 is configured to: extract a book list title and/or a book list introduction from the video materials, and take the book list title and/or the book list introduction as a text content at the first screen position of a corresponding video in the long text; and extract a book identifier and recommendation information of the books to be recommended from the video materials, and sequentially arrange the book identifier and recommendation information of the books to be recommended in other positions of the long text; and set a reading mode of the long text as a scrolling playback mode to generate a recommendation video having a text content of the long text as a video content.

In a possible implementation, the book information corresponding to the books to be recommended includes introduction information and recommendation information of the books to be recommended; and the apparatus further includes the second processing module 94. The second processing module is configured to acquire the recommendation information corresponding to the books to be recommended in the following way: acquiring at least one piece of comment information associated with the books to be recommended; in response to the at least one piece of comment information including the first comment information and books commented by the first comment information only including the books to be recommended, taking the first comment information as the recommendation information; or, in response to the at least one piece of comment information including the second comment information and books commented by the second comment information including the books to be recommended and other books, selecting target comment information from the second comment information based on comment attribute information of the second comment information in a plurality of comment dimensions, and taking a comment text segment associated with the books to be recommended in the target comment information as the recommendation information of the books to be recommended.

In a possible implementation, when displaying a recommendation video corresponding to a target book list, the first displaying module 91 is configured to display the recommendation video in the first area of a recommendation video page, and display a reading list generated based on the books to be recommended in the second area associated with the first area. When displaying, in response to a triggering operation on any of the books to be recommended in the recommendation video, a reading page corresponding to the book to be recommended, the second displaying module 92 is configured to, in response to a triggering operation on any of the books to be recommended in the reading list, display the reading page corresponding to the book to be recommended.

In a possible implementation, when displaying a reading list generated based on the books to be recommended in a second area, the second displaying module 92 is configured to: display a list identifier corresponding to the reading list in the second area, and display the reading list in response to a triggering operation on the list identifier; and/or, determine a book to be recommended that is associated with a current playback position of the recommendation video, and display the book to be recommended in the reading list in the second area.

In a possible implementation, the triggering operation includes a preset triggering operation. When displaying, in response to a triggering operation on any of the books to be recommended in the recommendation video, a reading page corresponding to the book to be recommended, the second displaying module 92 is configured to: determine a target playback position indicated by the preset triggering operation in the recommendation video, in order to determine a book to be recommended that is associated with the preset triggering operation based on the target playback position, and display the reading page corresponding to the book to be recommended.

In a possible implementation, the apparatus further includes the third displaying module 95, which is configured to display a book list display page corresponding to the target book list. The book list display page is used for displaying book information corresponding respectively to a plurality of books to be recommended in the target book list.

In a possible implementation, when displaying a book list display page corresponding to the target book list, the third displaying module 95 is configured to: display respectively the book information corresponding to the books to be recommended, in a plurality of the third areas in the book list display page, in which any of the third areas includes the first sub-area for displaying introduction information in the book information of the book to be recommended, and the second sub-area for displaying recommendation information in the book information; and display book list information of the target book list in the fourth area of the book list display page, in which a plurality of attribute dimensions in the book list information include at least one of a book list name of the target book list, a book quantity corresponding to the books to be recommended in the target book list, and a comprehensive reading conversion rate corresponding to the books to be recommended.

The description of the processing flow of modules in the apparatus and the interaction flow between the modules may refer to the relevant description in the above-mentioned method embodiments, and details will not be described here.

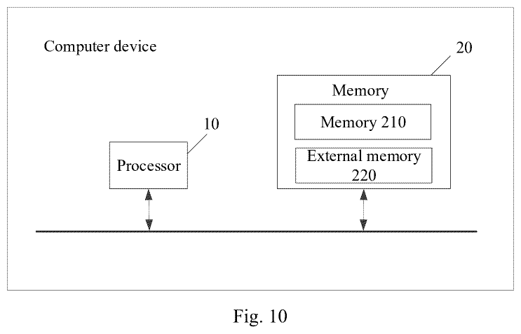

The embodiments of the present disclosure further provide a computer device, as shown in FIG. 10, which is a schematic diagram of a computer device provided by an embodiment of the present disclosure, the computer device includes a processor 10 and a memory 20.

The memory 20 stores machine-readable instructions executable by the processor 10, the processor 10 is used for executing the machine-readable instructions stored in the memory 20, and when the machine-readable instructions are executed by the processor 10, the processor 10 executes the following steps:
displaying a recommendation video corresponding to a target book list, in which the recommendation video is used for recommending books to be recommended that are associated with the target book list, and the recommendation video is generated based on book information corresponding to the books to be recommended; and displaying, in response to a triggering operation on any of the books to be recommended in the recommendation video, a reading page corresponding to the book to be recommended.

The memory 20 includes a memory 210 and an external memory 220. The memory 210 here is also called the internal memory, which is used for temporarily storing the operation data in processor 10 and the data exchanged with the external memory 220 such as a hard disk. The processor 10 exchanges data with the external memory 220 through the memory 210.

The specific execution process of the above-mentioned instructions may refer to the steps of the information display method in the embodiments of the present disclosure, which will not be repeated here.

The embodiments of the present disclosure further provide a computer-readable storage medium. Computer programs are stored on the computer-readable storage medium, and when the computer programs are run by a processor, the steps of the information presentation method in the above-mentioned method embodiments are executed. The storage medium may be a volatile or non-volatile computer-readable storage medium.

The embodiments of the present disclosure further provide a computer program product, which carries program codes, and the instructions included in the program codes can be used to execute the steps of the information display method in the above-mentioned method embodiments. The specific can refer to the above-mentioned method embodiments, and will not be repeated here.

The computer program product may be implemented in hardware, software, or a combination of the hardware and software. In an optional embodiment, the computer program product is specifically embodied as a computer storage medium, and in another optional embodiment, the computer program product is specifically embodied in a software product, such as a software development kit (SDK), etc.

Those skilled in the art can clearly understand that, for the convenience and conciseness of the description, the specific working process of the apparatus described above may refer to the corresponding process in the aforesaid method embodiments, which will not be repeated herein. In some embodiments provided in the present disclosure, it should be understood that the apparatus and method disclosed can be implemented by other means. The apparatus embodiments described above are only schematic, for example, the division of the units is only a logical function division, and there may be another division method when the apparatus is actually implemented, and for example, a plurality of units or components can be combined, or some features can be ignored or not executed. On the other hand, the coupling or direct coupling or communication connection between each other shown or discussed may be indirect coupling or communication connection through some communication interfaces, apparatuses or units, which may be in electrical, mechanical or other form.

The unit described as a separate component may be or may not be physically separated, and the component displayed as a unit may be or may not be a physical unit, i.e., may be located in a place, or may also be distributed on a plurality of network units. Some or all of the units can be selected according to actual needs to implement the purpose of the present embodiment solution.

In addition, the functional units in the embodiments of the present disclosure may be integrated in a processing unit, or each unit may exist separately physically, or two or more than two units may be integrated in a unit.

If the described function is implemented in the form of a software functional unit and marketed or used as an independent product, the function may be stored in a non-volatile computer-readable storage medium that can be executed by a processor. Based on this understanding, the technical solution of the present disclosure in essence or the part that contributes to the prior art or the part of the technical solution may be embodied in the form of a software product, and the computer software product is stored in a storage medium that includes several instructions for enabling a computer device (which may be a personal computer, a server, or a network device, etc.) to execute all or part of the steps of the method described in the embodiments of the present disclosure. The aforementioned storage medium includes various media that can store program codes, such as a USB flash drive, a mobile hard disk, a Read-Only Memory (ROM), a Random Access Memory (RAM), a disk, an optical disc, etc.

Finally, it should be noted that the above-mentioned embodiments are only specific embodiments of the present disclosure, which are used to illustrate the technical solutions of the present disclosure and not to limit them, and the scope of protection of the present disclosure is not limited to this. Although the present disclosure is described in detail with reference to the aforesaid embodiments, a person skilled in the art should understand that any person skilled in the art who is familiar with the art can still modify the technical solutions described in the aforesaid embodiments or can easily think of changes within the scope of the technology disclosed in the disclosure, or the equivalent substitution of some of the technical features. These modifications, changes or substitutions do not depart the essence of the corresponding technical solutions from the spirit and scope of the technical solutions of the embodiments of the present disclosure, which shall be covered in the scope of protection of the present disclosure. Therefore, the scope of protection of the present disclosure shall be stated in accordance with the scope of protection of the claims.

1. An information display method, comprising:
displaying a recommendation video corresponding to a target book list, wherein the recommendation video is used for recommending books to be recommended that are associated with the target book list, and the recommendation video is generated based on book information corresponding to the books to be recommended; and
displaying, in response to a triggering operation on a target book to be recommended in the recommendation video, a reading page corresponding to the target book to be recommended.

2. The method according to claim 1, wherein the recommendation video corresponding to the target book list is determined in a following way:
determining video materials for generating the recommendation video based on the book information corresponding to the books to be recommended; and
determining a target video type that matches the target book list from a plurality of preset video types, and generating a recommendation video under the target video type for the target book list based on the video materials.

3. The method according to claim 2, wherein the determining video materials for generating the recommendation video based on the book information corresponding to the books to be recommended, comprises:
acquiring book list information of the target book list, wherein the book list information characterizes introduction information of the target book list in a plurality of attribute dimensions; and
determining the video materials for generating the recommendation video based on the book information corresponding to the books to be recommended and the book list information.

4. The method according to claim 2, wherein the preset video types comprise a plurality of types selected from a group of an explanatory type, an image set type and a text reading type; and
the generating a recommendation video under the target video type for the target book list based on the video materials, comprises:
integrating the video materials to obtain the recommendation video according to a video material integration mode corresponding to the target video type.

5. The method according to claim 4, wherein the target video type comprises the explanatory type, and a video material integration mode corresponding to the explanatory type comprises: using different video clips to associate with video materials of different books to be recommended; and
the integrating the video materials to obtain the recommendation video according to a video material integration mode corresponding to the target video type, comprises:
extracting a book list title and/or a book list introduction from the video materials, and generating a video cover of the recommendation video according to the book list title and/or the book list introduction; and
extracting a book identifier and recommendation information of the books to be recommended from the video materials, and generating a plurality of video clips of the recommendation video according to the book identifier and recommendation information of the books to be recommended, wherein the different video clips are associated with the different books to be recommended.

6. The method according to claim 4, wherein the target video type comprises the image set type, and a video material integration mode corresponding to the image set type comprises: using different video image sets to associate with video materials of different books to be recommended, and using different video images in the video image set to associate with video materials of different information types respectively; and
the integrating the video materials to obtain the recommendation video according to a video material integration mode corresponding to the target video type, comprises:
extracting video materials of the books to be recommended respectively under the plurality of the information types from the video materials; and
generating the video image sets according to the video materials of the books to be recommended, wherein each video image set is used to present the video materials of the corresponding book to be recommended under the plurality of the information types.

7. The method according to claim 4, wherein the target video type comprises the text reading type, and a video material integration mode corresponding to the text reading type comprises: displaying the video materials in a form of a long text, the long text refers to a text that is longer than a length of a screen; and
integrating the video materials to obtain the recommendation video according to a video material integration mode corresponding to the target video type, comprises:
extracting a book list title and/or a book list introduction from the video materials, and taking the book list title and/or the book list introduction as a text content at a first screen position of a corresponding video in the long text; extracting a book identifier and recommendation information of the books to be recommended from the video materials, and sequentially arranging the book identifier and recommendation information of the books to be recommended in other positions of the long text; and
setting a reading mode of the long text as a scrolling playback mode to generate a recommendation video having a text content of the long text as a video content.

8. The method according to claim 2, wherein the book information corresponding to the books to be recommended comprises introduction information and recommendation information of the books to be recommended; and the method further comprises: acquiring the recommendation information corresponding to the books to be recommended in a following way:
acquiring at least one piece of comment information associated with the books to be recommended;
in response to the at least one piece of comment information comprising first comment information and books commented in the first comment information only comprising the books to be recommended, taking the first comment information as the recommendation information; or
in response to the at least one piece of comment information comprising second comment information and books commented in the second comment information comprising the books to be recommended and other books, selecting target comment information from the second comment information based on comment attribute information of the second comment information in a plurality of comment dimensions, and taking a comment text segment associated with the books to be recommended in the target comment information as the recommendation information of the books to be recommended.

9. The method according to claim 1, wherein the displaying a recommendation video corresponding to a target book list, comprises:
displaying the recommendation video in a first area of a recommendation video page, and displaying a reading list generated based on the books to be recommended in a second area associated with the first area; and
the displaying, in response to a triggering operation on a target book to be recommended in the recommendation video, a reading page corresponding to the target book to be recommended, comprises:
in response to a triggering operation on the target book to be recommended in the reading list, displaying the reading page corresponding to the target book to be recommended.

10. The method according to claim 9, wherein the displaying a reading list generated based on the books to be recommended in a second area, comprises:
displaying a list identifier corresponding to the reading list in the second area, and displaying the reading list in response to a triggering operation on the list identifier; and/or,
determining a book to be recommended that is associated with a current playback position of the recommendation video, and displaying the book to be recommended in the reading list in the second area.

11. The method according to claim 1, wherein the triggering operation comprises a preset triggering operation; and the displaying, in response to a triggering operation on a target book to be recommended in the recommendation video, a reading page corresponding to the target book to be recommended, comprises:
determining a target playback position indicated by the preset triggering operation in the recommendation video, in order to determine the target book to be recommended that is associated with the preset triggering operation based on the target playback position, and displaying the reading page corresponding to the target book to be recommended.

12. The method according to claim 1, further comprising:
displaying a book list display page corresponding to the target book list, wherein the book list display page is used for displaying book information corresponding respectively to a plurality of books to be recommended in the target book list.

13. The method according to claim 12, wherein the displaying a book list display page corresponding to the target book list, comprises:
displaying respectively the book information corresponding to the books to be recommended, in a plurality of third areas in the book list display page, wherein any of the third areas comprises a first sub-area for displaying introduction information in the book information of the book to be recommended, and a second sub-area for displaying recommendation information in the book information; and
displaying book list information of the target book list in a fourth area of the book list display page, wherein a plurality of attribute dimensions in the book list information comprise at least one of a book list name of the target book list, a book quantity corresponding to the books to be recommended in the target book list, and a comprehensive reading conversion rate corresponding to the books to be recommended.

14. (canceled)

15. A computer device, comprising:
at least one processor and at least one memory,
wherein the at least one memory stores machine-readable instructions executable by the at least one processor, the at least one processor is used for executing the machine-readable instructions stored in the at least one memory, and when the machine-readable instructions are executed by the at least one processor, the at least one processor executes the steps of an information display method, and the information display method comprises:
displaying a recommendation video corresponding to a target book list, wherein the recommendation video is used for recommending books to be recommended that are associated with the target book list, and the recommendation video is generated based on book information corresponding to the books to be recommended; and
displaying, in response to a triggering operation on a target book to be recommended in the recommendation video, a reading page corresponding to the target book to be recommended.

16. A non-transient computer-readable storage medium, wherein computer programs are stored on the non-transient computer-readable storage medium, and when the computer programs are run on a computer device, the computer device executes the steps of an information display method, and the information display method comprises:
displaying a recommendation video corresponding to a target book list, wherein the recommendation video is used for recommending books to be recommended that are associated with the target book list, and the recommendation video is generated based on book information corresponding to the books to be recommended; and
displaying, in response to a triggering operation on a target book to be recommended in the recommendation video, a reading page corresponding to the target book to be recommended.

17. The computer device according to claim 15, wherein the recommendation video corresponding to the target book list is determined in a following way:
determining video materials for generating the recommendation video based on the book information corresponding to the books to be recommended; and
determining a target video type that matches the target book list from a plurality of preset video types, and generating a recommendation video under the target video type for the target book list based on the video materials.

18. The computer device according to claim 17, wherein the determining video materials for generating the recommendation video based on the book information corresponding to the books to be recommended, comprises:
acquiring book list information of the target book list, wherein the book list information characterizes introduction information of the target book list in a plurality of attribute dimensions; and
determining the video materials for generating the recommendation video based on the book information corresponding to the books to be recommended and the book list information.

19. The computer device according to claim 17, wherein the preset video types comprise a plurality of types selected from a group of an explanatory type, an image set type and a text reading type; and
the generating a recommendation video under the target video type for the target book list based on the video materials, comprises:
integrating the video materials to obtain the recommendation video according to a video material integration mode corresponding to the target video type.

20. The non-transient computer-readable storage medium according to claim 16, wherein the recommendation video corresponding to the target book list is determined in a following way:
determining video materials for generating the recommendation video based on the book information corresponding to the books to be recommended; and
determining a target video type that matches the target book list from a plurality of preset video types, and generating a recommendation video under the target video type for the target book list based on the video materials.

21. The non-transient computer-readable storage medium according to claim 20, wherein the determining video materials for generating the recommendation video based on the book information corresponding to the books to be recommended, comprises:
acquiring book list information of the target book list, wherein the book list information characterizes introduction information of the target book list in a plurality of attribute dimensions; and
determining the video materials for generating the recommendation video based on the book information corresponding to the books to be recommended and the book list information.
